(19) United States
(12) Patent Application Publication
(10) Pub. No.: US 2013/0057401 A1
(43) Pub. Date: Mar. 7, 2013

(54) EMERGENCY INFORMATION COMMUNICATOR

(71) Applicant: JAMES THOMAS RATES, Port Orange, FL (US)

(72) Inventor: JAMES THOMAS RATES, Port Orange, FL (US)

(73) Assignee: DELPHON INDUSTRIES, LLC, Hayward, CA (US)

(21) Appl. No.: 13/528,687

(22) Filed: Jun. 20, 2012

Related U.S. Application Data
(60) Provisional application No. 61/532,095, filed on Sep. 7, 2011.

(51) Int. Cl. H04W 84/12; G08B 1/08

(52) U.S. Cl. 340/539.1

(57) ABSTRACT

Provided is a system and device for transmitting unencrypted information regarding a structure for use by first responders. The system and device includes an alarm housing and a WLAN housing, which may be in a single unit or in separate units. Upon detection of an emergency event, the alarm housing will sound an alarm and the WLAN housing will begin transmitting information about the structure, which may be detected using established first responder infrastructure, such as computers equipped in emergency responder vehicles.

### CROSS-REFERENCE TO RELATED APPLICATIONS

The present invention claims priority to U.S. Provisional Patent Application No. 61/532,095, filed on Sep. 7, 2011, which is incorporated herein in its entirety.

### TECHNICAL FIELD

The present invention relates generally to security systems. More specifically, the present invention relates to emergency notification systems for use by first responders.

### BACKGROUND OF THE INVENTION

An alarm system, such as a smoke detector, is typically used to detect the presence of an unwanted fire in an enclosed structure. In its simplest form, a smoke detector consists of two parts: a sensor to sense smoke and an audible alarm to alert inhabitants of the facility that a fire has started. Smoke detectors typically run off of a 9-volt battery, a lithium battery, or are hardwired into the structure's electrical system.

When a first responder, such as the police or a fire department, is alerted to an emergency within a structure, such as a fire, the first responder typically has no information regarding the interior of the structure. In order to obtain information regarding the structure, such as the number of persons within the structure or the presence of animals, the first responder must seek to obtain the information from inhabitants of the structure or from other persons familiar with the structure. Because obtaining this information is a time-consuming and imprecise exercise, the lives of any humans and animals within the structure may be placed in unnecessary danger.

To ensure the safety of the inhabitants within a structure in the event of an emergency, there is a need for a more effective way for first responders to obtain information regarding the inhabitants of a structure.

### SUMMARY OF THE INVENTION

The present invention fulfills the need in the art by providing a system comprising: an emergency detector for detecting an emergency event in a structure; an alarm driver coupled to the emergency detector; a latched relay; and a wireless local area network (WLAN) pre-programmed with information regarding the structure, wherein upon detection of the emergency event by the emergency detector, the alarm driver activates the latched relay to transmit power to the WLAN to transmit a wireless signal with the information regarding the structure.

The present invention further provides a device comprising: an emergency detector for detecting an emergency event in a structure; an alarm driver coupled to the emergency detector, wherein an emergency event activates the alarm driver; a latched relay configured to be activated by the alarm driver; a wireless local area network (WLAN) pre-programmed with information regarding the structure, wherein the WLAN transmits a wireless signal with the preprogrammed information upon receipt of power from the latched relay.

In one embodiment, the wireless signal is unencrypted.

In another embodiment, the emergency detector, alarm driver, latched relay, and WLAN comprise a single unit.

In a further embodiment, the emergency detector and the alarm driver are housed in a single unit and the latched relay and WLAN are housed in a separate unit.

In another embodiment, the system and/or the latched relay/WLAN unit further comprises a reset switch and/or a battery.

In a further embodiment, the information regarding the structure comprises physical information on the interior of the structure, including information regarding critical services of the structure and/or information regarding the structure includes information on inhabitants or occupants of the structure.

In another embodiment of the invention, the emergency event is a fire and/or a gas leak.

Additional aspects and embodiments of the invention will be provided, without limitation, in the detailed description of the invention that is set forth below.

### BRIEF DESCRIPTION OF THE DRAWINGS

FIG. 1 shows a block diagram of an embodiment of the emergency information communicator (EIC) system of the present invention.

FIG. 2 shows a schematic of an embodiment of the EIC system of the present invention.

FIG. 3 shows a schematic diagram of a hardwired EIC system of the present invention.

FIG. 4 shows a schematic diagram of an audio connected EIC system of the present invention.

FIG. 5 shows a schematic diagram of a radio frequency (RF) connected EIC system of the present invention.

### DETAILED DESCRIPTION OF THE INVENTION

Set forth below is a description of what are currently believed to be preferred embodiments of the claimed invention. Any alternates or modifications in function, purpose, or structure are intended to be covered by the claims of this application. As used in this specification and the appended claims, the singular forms “a,” “an,” and “the” include plural referents unless the context clearly dictates otherwise. The terms “comprises” and/or “comprising,” as used in this specification and the appended claims, specify the presence of stated features, integers, steps, operations, elements, and/or components, but do not preclude the presence or addition of one or more other features, integers, steps, operations, elements, components, and/or groups thereof.

The term “first responders” as used herein is meant to refer to any emergency response unit, such as for example, the police, the fire department, or the hazardous materials unit.

The term “structure” as used herein is meant to refer to any facility that is used for residential or commercial use, such as for example, a house, a mobile unit, a commercial building, an office building, a mixed-use facility, a hospital, a clinical, a factory, a warehouse, an industrial complex, and animal facilities located in a pet store, an animal shelter, a zoo, or an aquarium.

The terms “emergency” and “hazard” as used herein are meant to refer to any event that places an inhabitant in peril and/or danger, such as for example, a fire or gas leak. The terms “emergency” and “hazard” are used interchangeably herein to refer to the same and/or similar situations of potential peril and/or danger.

As used herein, the term “inhabitants” is meant to refer to any person or animal that is present or lives within a residential structure and the term “occupants” is meant to refer to any person or animal that is present or works within a commercial or industrial structure. The term “person” is meant to include adults, children, including disabled adults and children. The term “animal” is meant to include domesticated pets and undomesticated animals.

The term “critical services” is meant to refer to devices and materials within a structure, such as for example, main power boxes, water cut-offs, and the location of dangerous chemicals, materials, and gasses, such as propane or oxygen tanks.

The term “emergency device” is meant to refer to any emergency detector, such as for example, a fire detector, a smoke detector, or a hazardous gas detector.

The present invention provides an EIC system comprising an emergency detector coupled to a wireless local area network (WLAN) transmitter. When the emergency detector identifies an emergency, the emergency detector sounds an alarm while simultaneously sending a signal to an interface circuit that enables a WLAN to transmit information regarding the structure. Information that may be programmed into the WLAN component of the EIC system, by the user, includes, without limitation, information regarding the dimensions and number of floors of the structure, the location of critical services within and around the structure, the points of access to rooms within the structure, and the number of inhabitants or occupants of the structure.

The system of the present invention is intended to make use of existing fire and police department infrastructure, such as the computers equipped in emergency responder vehicles. The transmitted information from the WLAN enables first responders that arrive at the scene of the emergency to have information regarding the structure and its inhabitants or occupants prior to entering into the structure. The information emitted from the WLAN may be accessed by the first responder by simply detecting available WLAN signals at the scene of the emergency. This signal will preferably be unencrypted and available to any computer or special receiver capable of receiving wireless signals. Wireless signals that are capable of use with the present invention include without limitation, 802.11b, 802.11g, and 802.11n signals. It is to be understood that the EIC system set forth herein is intended to be modified to comply with the latest wireless technology. The WLAN transmitter will continue to emit a signal from the time the emergency detector sounds the alarm until it is reset manually by the user or the first responder.

In one embodiment of the invention, the EIC system is a single unit comprised of an emergency detector, a wireless transmitter, and a battery within the same housing. This single unit configuration has the advantage of being inexpensive to produce; however, it would be subject to or susceptible to damage caused by the emergency event it is detecting (such as for example, a fire). In a preferred embodiment, several single unit EIC devices would be deployed within a structure to provide redundancy. With this embodiment, each individual EIC unit would sound an alarm and present data until it is destroyed by the emergency event.

In another embodiment of the invention, the EIC system of the present invention is comprised of separate components, each of which has its own individual housing. In such an embodiment, one or more emergency detectors would be located in an area or areas of the structure and the WLAN transmitter would be located in a remote location away from the main structure. Within a residential setting, examples of safe locations for the WLAN transmitter would be a garage or a container and/or housing, such as for example a metal box, located outside of the structure. Within a commercial or industrial complex, examples of safe locations for the WLAN transmitted would be a metal box located outside of one or more of the buildings in the commercial or industrial complex.

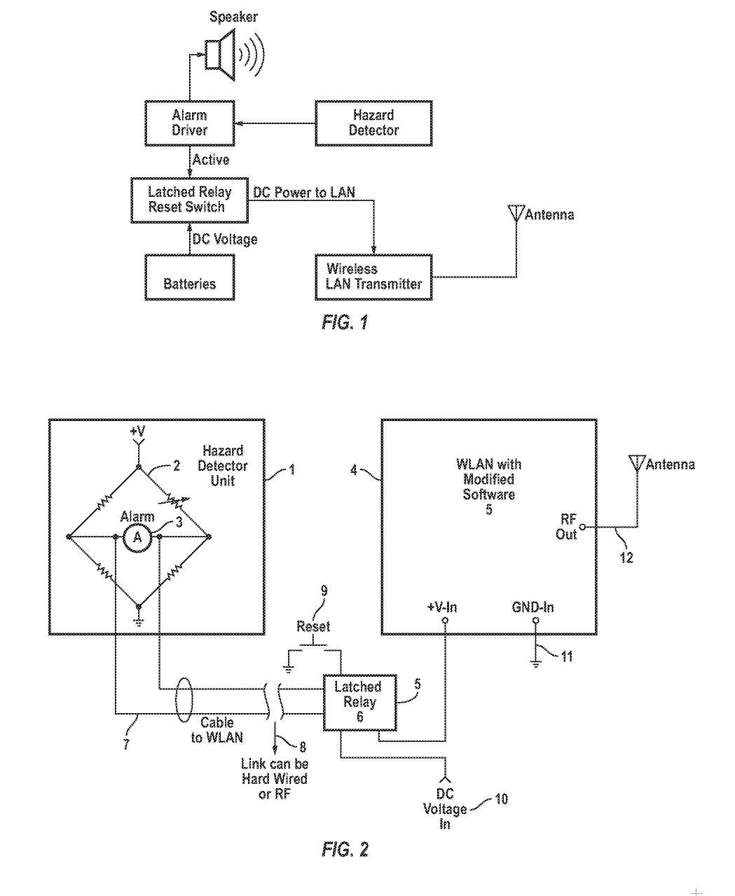

FIG. 1 shows a block diagram of the EIC system of the present invention. As shown therein, a hazard detector, such as for example a smoke or gas detector, is coupled to an alarm driver. When the detector identifies the hazard, such as smoke or fire, the driver activates a speaker, which sounds an alarm. The activation of the alarm driver simultaneously actives the latched relay, which sends an electrical current, such as for example, a direct current (DC) to the WLAN, which proceeds to transmit the information programmed into the WLAN by way of an antenna to any available receiver of the information. The information from the WLAN will continue to transmit until it is turned off by way of a reset switch (shown in FIG. 1 in the same box as the latched relay). With the single unit EIC system, each individual component as shown in FIG. 1 is within a single housing. With the multiple component EIC system, each individual component and/or combination of components may be housed in separate units. In a preferred embodiment of the invention, the emergency/hazard detector, alarm driver, and speaker may be housed within a single unit and the latched relay, reset switch, WLAN, and batteries may be housed in a separate unit.

FIG. 2 shows a schematic diagram of the EIC system of the present invention. In FIG. 2, the emergency detector 2 and alarm 3 are shown as housed within an alarm housing 1 and the WLAN 5 is shown within a WLAN housing 4. The latched relay 6 is preferably within the WLAN housing 4 (not shown); however, the system may be designed such that the latched relay 6 is in a separate latched relay housing 5 as is shown in FIG. 2. The alarm 3 within the alarm housing 1 may be connected to the latched relay 6 by a cable 7. The link 8 between the cable 7 from the alarm housing 1 may be by hardwire, audio, or RF connection. The reset switch 9 will be preferably, though not necessarily, connected to the latched relay 6. In a preferred embodiment of the invention, an electrical current, such as for example a DC voltage 10, passes through the latched relay 6 into the WLAN 5 causing the WLAN 5 to be grounded 11. The transmission of the information programmed into the WLAN 5 may be transmitted via an RF antenna 12.

In one embodiment of the invention, the latched relay 6 and the reset switch 9 are both within the WLAN housing 4. Upon the detection of an emergency by the emergency detector 2, the signal from the emergency detector 2 triggers the latched relay 6, which initiates the transmission of information from the WLAN 5. The WLAN 5 will continue to transmit the information until the WLAN housing 4 is destroyed by the emergency event or the signal is turned off (i.e., unlatched) by the reset switch 9.

In another embodiment of the invention, the WLAN is modified such that the information regarding the structure may be inputted into the WLAN. The modification will include, without limitation, an increase in the available memory of the WLAN. When the WLAN is programmed by the user, the user inputs not only the name of the WLAN, but also the information regarding the structure. Examples 1 and 2 demonstrate information that may be inputted into the WLAN for a residential structure (Example 1) and a commercial structure (Example 2). In a preferred embodiment of the invention, the information is inputted into the WLAN by way of a computer that is connected to the WLAN by way of a device, such as for example, a USB. Under the current IEEE 802.11 wireless standards, WLAN names, which are entered into the service set identifier (SSID) section of the WLAN, are limited to 32 characters. In this regard, one of skill in the art will appreciate that the WLAN of the present invention will be modified to be outside of the current 802.11 standards such that the information described herein, which will typically be in excess of 32 characters, may be inputted directly into and transmitted directly from the WLAN. One of skill in the art will appreciate that the software of the EIC device of the present invention will be different from the software used in IEEE 802.11 standard WLANs and that the hardware for the EIC device of the present invention may also differ from the hardware used to house IEEE 802.11 standard protocols.

In another embodiment of the invention, the WLAN may be programmed with a smart phone or other computerized device that may connected to the WLAN. In a further embodiment, the WLAN may be programmed directly by way of a programming interface device, such as for example, a keypad that may be integrated into the WLAN or sold separately and connected to the WLAN by a USB or other connecting device.

An advantage of the EIC system of the present invention is that the WLAN transmitter need not be as complicated as current commercially available WLAN devices. Commercially available WLAN devices are designed to accept an Internet signal from a source and broadcast it locally throughout a structure. By contrast, the EIC system of the present invention does not require the capability to broadcast an Internet signal; therefore the bandwidth necessary to broadcast an Internet signal is not needed with the WLAN component of the EIC system of the present invention. In this regard, the cost of producing the WLAN component of the EIC system of the present invention is significantly less that the cost of producing WLAN devices for Internet broadcasting. In order to run the WLAN component of the EIC system, all that is required is that the WLAN is capable of identifying itself and has expanded memory to store the necessary information for broadcasting. The emergency detector is preferably powered by a battery, such as for example, a 9-volt battery or a lithium battery, which is replaced periodically.

Where there are multiple detectors within a structure, the emergency detectors may be wired together and/or networked such that when a single emergency detector detects an emergency situation, all of the emergency detectors in the building sound an alarm. In one embodiment, the emergency detector is wired into the electrical system of the structure such that the emergency detector does not require an individual battery to run. The power running the emergency detector must be sufficient to ensure that the signal from the emergency detector will be received by the WLAN. If the emergency detector is powered by the wiring within the structure, such as for example, by a two wire twisted pair, the power should be sufficient to deliver the signal to the WLAN. If the connection between the emergency detector and the WLAN transmitter is electronic, such as for example, by radio-frequency (RF) connectors, such as BLUETOOTH® (Bluetooth Signal, Inc., Kirkland, Wash.) or ZIGBEE® (Zigbee Alliance Corp., San Ramon, Calif.), then the emergency detector must have sufficient power to be able to deliver signal to the WLAN; such additional power may be in the form of a larger battery supply for the emergency detector.

The WLAN will typically require sufficient energy to transmit the information stored therein for at least one hour. The WLAN will typically be powered by an uninterruptible power source (UPS) charged by 110 volt AC power (such as for example in the US) or 220 volt AC power (such as for example in Europe). The AC power will typically be supplied from the electrical system of the structure itself, although AC power from other sources outside of the structure may also be acceptable. For example, where the AC power for the WLAN is supplied from within a single structure in a commercial or industrial complex, upon the trigger of an emergency event within the structure, the WLAN will transmit information to a first responder that is specific to the structure. By contrast, where the AC power for the WLAN is supplied in a common area of a commercial or industrial complex, WLAN within the common area will typically be populated with information for all of the buildings in the complex. In this way, even if the WLAN is triggered from an emergency event detected in only one of the buildings, the WLAN will still transmit information to the first responders about all of the buildings in the complex.

Once the WLAN has been activated, the emergency detector and/or alarm may be destroyed without affecting the broadcast message. By contrast, once activated, the WLAN will continue to broadcast the information stored therein until it is manually reset.

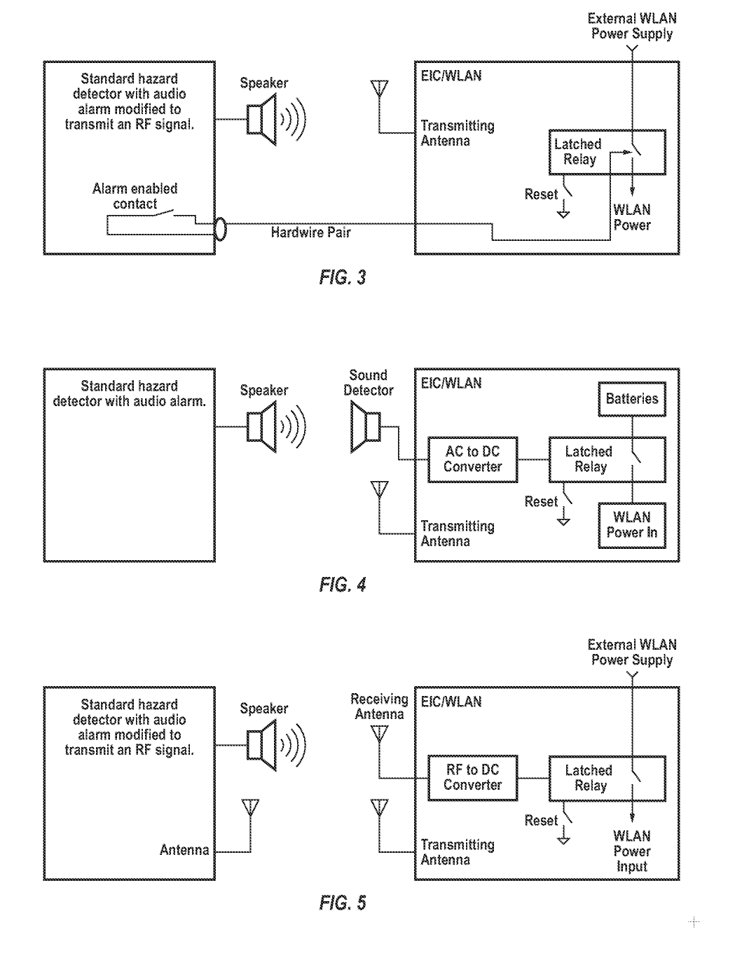

FIG. 3 shows a schematic diagram of a hardwire connected EIC system of the present invention; FIG. 4 shows a schematic diagram of an audio connected EIC system of the present invention; and FIG. 5 shows a schematic diagram of an RF connected EIC system of the present invention. In each embodiment, an emergency initiates the hazard detector to sound an alarm, which is transmitted to the EIC system in one of three ways.

In the hardwired system, the audio signal from the alarm is transmitted to the EIC by way of a wire from the hazard detector to the EIC system (FIG. 3). The wiring to control the hardwired EIC system of the present invention may be the structures internal wiring system or it may be a wiring system that is separate from the structure's internal wiring system. In the audio system, the audio signal transmitting from the alarm is received by a sound detector on the EIC system (FIG. 4). With the audio system, it is preferable if the EIC system is located in relatively close proximity to the hazard detector. In a typical household or business with several hazard detectors, it would be preferably to have several EICs deployed within the structure. The ratio of hazard detectors to EICs would be relative to the number and location of detectors in the structure. With the RF system, the audio signal from the alarm is transmitted by an antenna on the hazard alarm and received by an antenna on the EIC system (FIG. 5).

In each embodiment, the EIC's receipt of the emergency signal from the hazard detector triggers the EIC to transmit information stored within the system by way of a transmitting antenna (FIGS. 3, 4, and 5). In the hardwired system, the structure's wiring may serve as the transmitting antenna for the EIC system.

As shown in FIGS. 3-5, the EIC system for the hardwired, audio, and RF systems preferably include a latched relay, which maintains power in the EIC system even when the EIC ceases to receive signal from the hazard alarm. For example, in the hardwired system, the latched relay will maintain power to the EIC when the connection is severed and in the audio and RF systems, the latched relay will maintain power to the EIC when the sound from the hazard alarm ceases. In all three EIC systems, the latched relay will serve to maintain the flow of power to the EIC system until the system is reset or destroyed by the emergency event. As shown in FIG. 4, in the audio EIC system, the sound received by the EIC sound detector is converted from AC power to DC power for transmission to the latched relay. By contrast, as show in FIG. 5, in the RF system, the signal received by the EIC antenna is converted from RF to DC power for transmission to the latched relay.

In one embodiment of the invention, the external WLAN power supply of the hardwired and RF connected systems is a battery backup (UPS) system that is powered by AC voltage (FIGS. 3 and 5).

Examples of emergency events that may trigger the use of the EIC system and device are, without limitation, fires, smoke, and gas leaks. It is to be understood that the EIC system and device described herein is not intended to be limited to detecting fires and gas leaks, but may be used to detect any other emergency event, such as for example, a home invasion, a residential or commercial burglary, a water leak, a flood, and/or extreme temperatures (either hot or cold) within a structure.

It is to be understood that while the invention has been described in conjunction with the embodiments set forth above, the foregoing description as well as the examples that follow are intended to illustrate and not limit the scope of the invention. Further, it is to be understood that the embodiments and examples set forth herein are not exhaustive and that modifications and variations of the invention will be apparent to those of ordinary skill in the art without departing from the scope and spirit of the invention.

All patents and publications mentioned herein are incorporated by reference in their entireties.

### EXPERIMENTAL

The following examples are set forth to provide those of ordinary skill in the art with a complete disclosure of how to make and use the aspects and embodiments of the invention as set forth herein.

### Example 1

### Single Unit EIC Devices for Personal Home System

The following information is inputted into six single unit EIC devices for use in a two story residential home, wherein three of the EIC devices are placed in rooms on the first floor of the house and three of the EIC devices are placed in rooms on the second floor of the house:

Three bedroom, two-story home located at 1234 Local Lane Drive. Child-under-five bedroom on second floor, accessible through front left second floor window. Adolescent child bedroom on second floor, accessible through front right second floor window. Adult bedroom on second floor rear, accessible through second floor rear windows. Two pets: small non-vicious brown dog and small white cat. Propane grill on back screened porch, spare propane tank in garage. Gasoline lawn mower in garage with five-gallon gasoline tank. Two cars may be in the garage. House uses natural gas for heating, cooking, and drying. Gas cut-off and power breakers are on the outside left side of the house. Owner's cell phone number: 222-345-6789.

### Example 2

### Multiple Unit EIC Device for a Commercial Building

The following information is inputted into a separate component EIC device for use in a multiple story commercial building.

Four story commercial office building located at 1234 Business Park Drive. Pharmaceutical company including R&D lab occupies first floor; hospital accounting department and nursing training center share second floor; and private equity firm and law firm occupy fourth floor. Building breaker box, HVAC valve, and air intake valves are located within the entry of the first floor loading dock on the rear of the building. Gas cut-off is located on the north side of the building in a central location behind hedges. Water main is located five feet west of the gas cut-off. Hazardous chemical, biohazard materials, and oxygen tanks are located in the R&D lab. Surgical equipment, medical devices, and an incubator are located within the nursing center. Estimated number of occupants is 500 people. All rooms in all floors equipped with overhead sprinklers. Building has pressurized stairwells with 100% outdoor air. Security service 24 hr telephone: 800-123-4567.

I claim:

1. A system comprising:
an emergency detector for detecting an emergency event in a structure;
an alarm driver coupled to the emergency detector;
a latched relay; and
a wireless local area network (WLAN) pre-programmed with information regarding the structure; and
wherein upon detection of the emergency event by the emergency detector, the alarm driver activates the latched relay to transmit power to the WLAN to transmit a wireless signal with the information regarding the structure.

2. The system of claim 1, wherein the wireless signal is unencrypted.

3. The system of claim 1, wherein the emergency detector, alarm driver, latched relay, and WLAN comprise a single unit.

4. The system of claim 1, wherein the emergency detector and the alarm driver are housed in a single unit and the latched relay and WLAN are housed in a separate unit.

5. The system of claim 1, further comprising a reset switch.

6. The system of claim 1, further comprising a battery.

7. The system of claim 4, wherein the latched relay/WLAN unit further comprises a reset switch.

8. The system of claim 4, wherein the latched relay/WLAN unit further comprises a battery.

9. The system of claim 1, wherein the information regarding the structure comprises physical information on the interior of the structure.

10. The system of claim 1, wherein the information regarding the structure includes information regarding critical services of the structure.

11. The system of claim 1, wherein information regarding the structure includes information on inhabitants or occupants of the structure.

12. The system of claim 1, wherein the emergency event is a fire.

13. The system of claim 1, wherein the emergency event is a gas leak.

14. A device comprising:
an emergency detector for detecting an emergency event in a structure;
an alarm driver coupled to the emergency detector, wherein an emergency event activates the alarm driver;
a latched relay configured to be activated by the alarm driver;
a wireless local area network (WLAN) pre-programmed with information regarding the structure, wherein the WLAN transmits a wireless signal with the preprogrammed information upon receipt of power from the latched relay.

15. The device of claim 14, wherein the wireless signal is unencrypted.

16. The device of claim 14, wherein the emergency detector, alarm driver, latched relay, and WLAN comprise a single unit.

17. The device of claim 14, wherein the emergency detector and the alarm driver are housed in a single unit and the latched relay and WLAN are housed in a separate unit.

18. The device of claim 14, further comprising a reset switch coupled to the latched relay.

19. The device of claim 14, further comprising a battery.

20. The device of claim 17, wherein the latched relay/WLAN unit further comprises a reset switch.

21. The device of claim 17, wherein the latched relay/WLAN unit further comprises a battery.

22. The device of claim 14, wherein the information regarding the structure comprises physical information on the interior of the structure.

23. The device of claim 14, wherein the information regarding the structure includes information regarding critical services of the structure.

24. The device of claim 14, wherein information regarding the structure includes information on inhabitants or occupants of the structure.

25. The device of claim 14, wherein the emergency event is a fire.

26. The device of claim 14, wherein the emergency event is a gas leak.
